(19) United States
(12) Patent Application Publication
(10) Pub. No.: US 2007/0041554 A1
(43) Pub. Date: Feb. 22, 2007

(54) Method and system for comprehensive testing of network connections

(75) Inventors: Scott Andrew Newman, Little Elm, TX (US); Eric Bearden, Forney, TX (US); Alex W. Yip, Plano, TX (US); David Alen Henry, Dallas, TX (US); John-Paul Roadman, Carrollton, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/202,692

(22) Filed: Aug. 12, 2005

(51) Int. Cl. H04M 1/24; H04M 3/42

(52) U.S. Cl. 379/218.01; 379/1.01

(57) ABSTRACT

The present invention is an system and method for comprehensively testing a customer connection to a communications network. A customer is identified from information obtained at a customer interface. A test can be performed on the customer connection. A typical test compares two datasets related to the customer connection to determine a state of the customer connection. The first and second dataset can include historical data. A parameter in the first dataset obtained from a network element can be compared to a parameter in a second dataset obtained from a customer database. The comparison can be made in light of changes recorded in a provisioning database. Relevant network data can be obtained from customer premises equipment (CPE). The customer can be notified of a network issue proactively or upon customer inquiry.

### BACKGROUND OF THE INVENTION

1. Field of the Invention

The present invention relates to the field of testing data transfer services. In particular, the present invention provides a method and system for comprehensive testing of a connection to a network.

2. Description of the Related Art

New services are currently being introduced that expand upon Internet Protocol (IP). IP is a packet-switching technology for transporting information over Internet connections. Some exemplary IP services include Voice over Internet Protocol (VoIP) for making phone calls, and Internet Protocol Television (IPTV) to provide television programs and video content to a customer's television set. The introduction of these new services highlights the need for maintaining trouble-free customer IP connections.

In order to maintain a customer connection, the customer connection can be monitored periodically or checked upon request. A comprehensive testing and monitoring device should be able to address the various types of connections that are available to a customer. Various testing modules, like “ping” and “trace”, already test certain aspects of the customer connection. However, as the network connection carries more traffic and is counted on for greater reliability, testing connections will generally require more extensive knowledge of network status, configuration parameters, etc.

### SUMMARY OF THE INVENTION

The present invention provides a method and system for comprehensive testing of a customer connection to a communications network. Comprehensive testing is provided comprising testing at various stages of the network connection, such as customer premises equipment (CPE), telephone company equipment, and Internet Service Provider (ISP) equipment. Results of the testing and related configuration parameters are stored in a plurality of data sets related to a customer. A customer interface is provided wherein a customer connection can be identified from information obtained at the customer interface. In one embodiment, the customer interface is an Interactive Voice Recorder (IVR), which interacts with a customer over a telephonic connection. In another embodiment, the customer interface is a graphical user interface (GUI), such as a web page, that is accessible by a customer service operator. To monitor a customer connection, the present invention typically obtains at least a first dataset and a second dataset related to testing and/or configuration of the customer connection. A comparison can be made between parameters in the first dataset and parameters in the second dataset. The results of the comparison indicate a state of the customer connection and issues that may affect the connection, such as inoperative network devices, incorrect configuration parameters, etc.

In one aspect of the present invention, the first and second dataset can be obtained at a network element, such as a router. In one implementation, the first and second dataset include historical data, obtained at different times. The times can be determined by an operator. Differences, or changes, between a parameter such as a configuration parameter in the first dataset and the corresponding parameter in the second dataset can be flagged. Also, the first and second dataset can be compared in light of a change of a customer related parameter recorded in a provisioning database. In addition, a dataset can be obtained from the CPE, for instance, by operating a program at the CPE to check configuration parameters at the CPE. For example, a program can be made to operate on a personal computer to obtain values from a registry for a Windows™ operating system operating on the personal computer. In another implementation of the present invention, a parameter in the first dataset obtained from a network element can be compared to the same or a related parameter in a second dataset obtained from a customer database. If the parameter change between data sets occurs without a corresponding change entry in a provisioning data base a network problem or issue is indicated. The customer can be notified of any identified network problems.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of an exemplary embodiment, taken in conjunction with the accompanying drawings, in which like elements have been given like numerals.

FIG. 1 illustrates a high-level diagram of an exemplary implementation of the present invention;

FIG. 2 illustrates a user interface for identifying a customer connection;

FIG. 3 illustrates a user interface of the IP Tool for testing a connection with a static network IP address;

FIG. 4 illustrates an exemplary testing module for VoIP services;

FIG. 5 illustrates a dialog box with detailed test results;

FIG. 6 illustrates an exemplary module for testing IPTV service;

FIG. 7 illustrates a user interface for testing a connection with a dynamic network IP address;

FIG. 8 illustrates an exemplary module for determining authentication problems; and

FIG. 9 illustrates a flowchart of an exemplary method of the present invention.

### DETAILED DESCRIPTION OF THE INVENTION

In view of the above, the present invention through one or more of its various aspects and/or embodiments is presented to provide one or more advantages, such as those noted below.

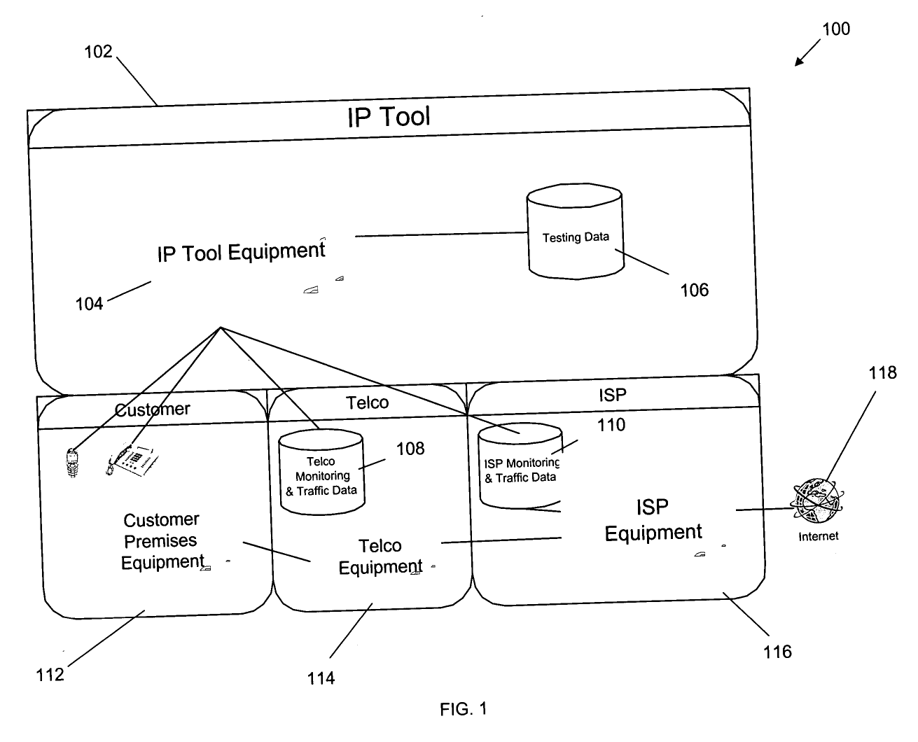

FIG. 1 illustrates a high-level diagram 100 of an exemplary implementation of the present invention. The present invention comprises an Internet Protocol Testing Tool (IP Tool) 102 for testing network elements used at various points in a customer network connection (“customer connection”). The customer connection generally comprises a connection from customer premises equipment (CPE) 112 through telephone company equipment (Telco Equipment) 114 and then through an Internet Service Provider (ISP) Equipment 116 to the Internet 118. The CPE generally refers to devices for which Internet Protocol (IP) services are provided, including a computer, an IP phone using VoIP, an IP television set and accompanying Set Top Box using IPTV, etc. The telephone company provides these IP services to the CPE. The Telephone company equipment typically comprises elements such as a DSLAM (Digital Subscriber Loop Access Multiplexer) which aggregates traffic from many DSL modems and sends it to Internet Service Providers. The ISP Equipment generally comprises a router for delivering and accessing packets to and from the Internet 118.

A software agent can be used to compile CPE data at the CPE 112. Such software agents are short diagnostic programs that can operate from the CPE and feed data back to the IP Tool, often using a commonly-used channel for data transmission, such as a port used for hypertext transfer protocol (HTTP) at a personal computer (PC). An agent typically obtains connectivity data at the CPE, such as local configuration parameters, etc. In one embodiment, an agent operating on a personal computer can examine a Microsoft Windows™ registry (a database of nearly all the settings for Windows™ and installed applications) of the PC. The agent can compare registry values to previously acquired registry data set values (e.g., acquired a few weeks prior). Changes in the registry can thereby be noted, such as could be due to a corrupted registry, for example, or by customer tinkering. Thus if the other network elements are working correctly, but the customer still cannot connect, the registry configuration parameters data sets can be checked. The IP Tool stores any changes a customer may make to any of the CPE by obtaining data sets from agents installed in CPE software. Additionally, the telephone company can assemble data sets from multiple CPE locations and create graphs for customers aggregated in one data set group, such as all customers at a point-of-presence (POP) connection to the network.

Telco Monitoring & Traffic Data database 108 typically compiles historical data sets obtained from various Telco equipment 114. Historical data sets are data obtained at various intervals, i.e., historically, such as hourly or daily. The IP Tool 102 can obtain the compiled data sets from the Telco Monitoring & Traffic Data database 108 and test for any performance degradation issues at the Telco equipment.

An ISP Monitoring & Traffic Data database 110 typically compiles historical data sets related to customer activity and traffic at the ISP 116. The IP Tool can obtain the compiled data sets from the ISP Monitoring & Traffic Data database 110 and use the data sets to determine any ISP problems.

The IP tool comprises IP Tool Equipment 104 and Testing Data database 106. The IP Tool Equipment 104 typically comprises a processor and a user interface for customer service. In an exemplary embodiment, the user interface comprises a Graphical User Interface for use by a customer service operator. In an alternative embodiment, the user interface comprises an Interactive Voice Responder (IVR) that interacts with the customer over a telephone connection. The Testing Data database 106 typically stores tests results in data sets that can be performed on the various network elements associated with the customer connection.

The IP Tool can continuously monitor network elements and perform tests at intervals determined by an operator. In an additional aspect of the present invention, the IP Tool reports any detected problems, such as a broken connection, a failed network element, an incorrect configuration parameter at a router, etc., to a Network Operating Center, which can alert the customer or network operator/user or prepare repair tickets to address the problem. When the network is continuously monitored, any detected problems can be flagged, and Ambush Alerts can be produced for customers. An Ambush Alert anticipates a customer service call and is presented to the customer upon calling into customer service. In the embodiment in which the user interface is an IVR, the IP Tool 102 can be activated upon receiving a customer service call. If a customer calls in about a network issue or problem that the IP Tool has already detected, the IVR can activate the Ambush Alert message to intercept the incoming call, inform the customer that an error has been detected, and provide an estimated amount of time before service resumes, etc. When a customer calls in, the IP Tool matches an identification number of the caller, typically a telephone number of the caller, to customer records and accesses a customer database comprising, among others, a data set including customer name, customer address, present status (i.e. whether the account is active or inactive), and any stored Ambush Alerts for the customer. The IP Tool 106 provides the Ambush Alerts to the customer via the customer interface. Alternatively, the IP Tool can call a customer to relay a message proactively to the customer when an issue arises. Additionally, the customer can choose through the IVR to be notified at a later time once the network event is resolved. This option reduces the number of customer service calls.

If the customer is experiencing authentication problems, such that the customer is unable to access the network, the customer can be given an option to reset a password over the phone using the IVR. The same option is available for notification of other network events. An appropriate business decision can be made concerning handling of issues due to connection failure at the telephone company. For example, a telephone company might address customer downtime through a refund policy.

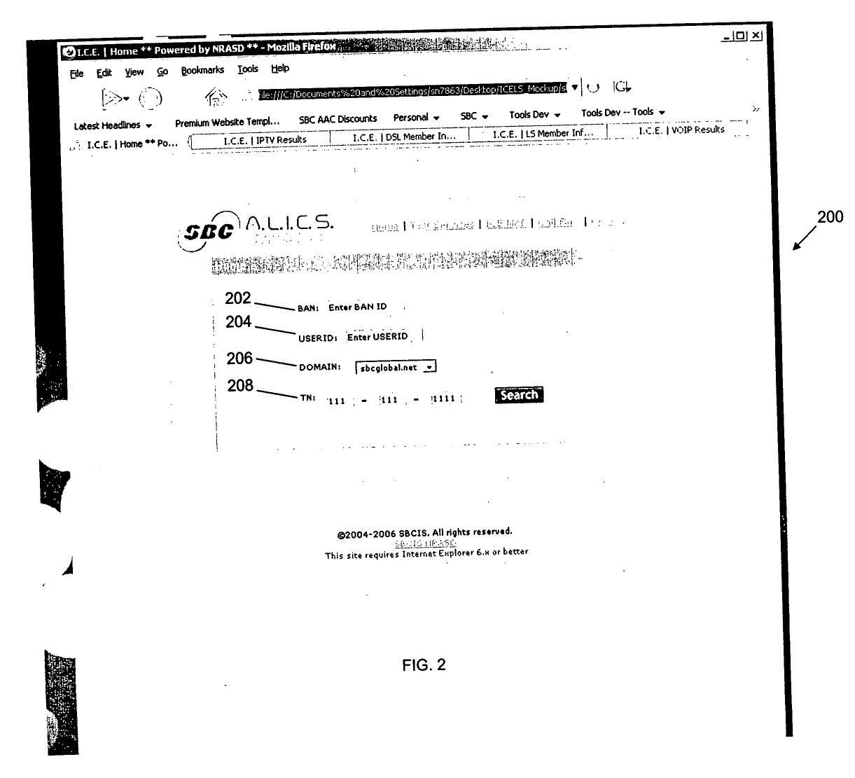

FIG. 2 illustrates a screenshot of an exemplary graphical user interface 200 usable by an operator in one aspect of the present invention to access the IP Tool 102 of FIG. 1. An operator enters information at interface 200 to identify the connection to be checked. In the exemplary embodiment of FIG. 2, this information includes a Billing Account Number (BAN ID) 202, a UserID 204, a domain 206, and a telephone number (TN) 208 of a caller placing a customer service call. Typically, the entered telephone number can be matched with a telephone number stored in a customer database, and any information, such as customer data, configuration parameters, etc., can be retrieved from the database as a data set.

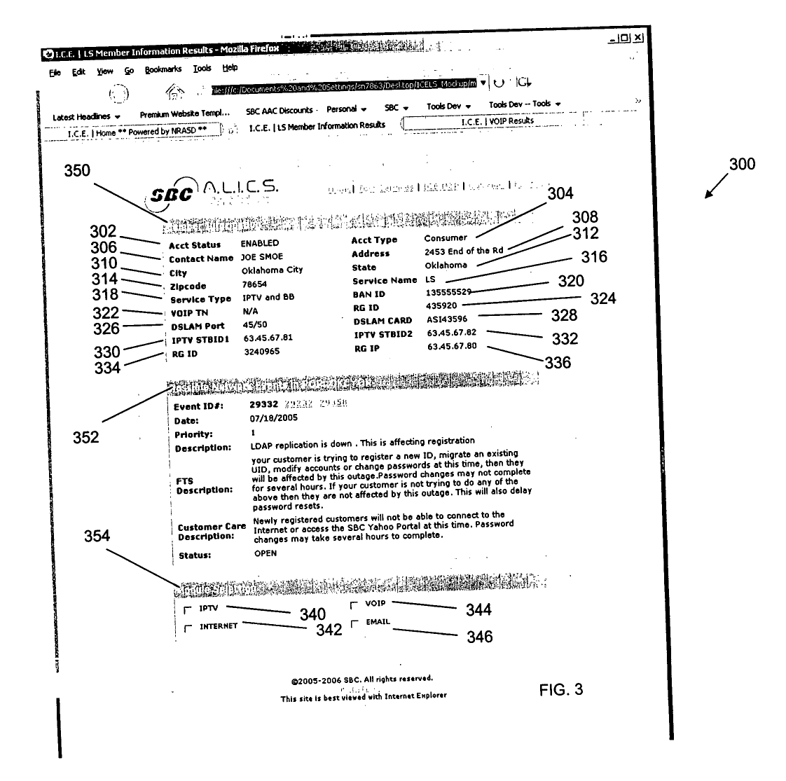

FIG. 3 illustrates a user/operator interface 300 of the IP Tool providing customer information and testing options for a customer having a static IP address connection. The static IP address is provided over a permanent network connection, as opposed to a dial-up connection. The user interface 300 provides a Member Information section 350 displaying pertinent customer information and configuration data, a Possible Network Events section 352 displaying the network events that have already been detected that may be affecting the customer, and a Module Selection section 354 providing a selection of testing modules. In the exemplary embodiment of FIG. 3, the Member Information section includes data sets and fields related to customer information, such as Account Status 302, Account Type 304, Contact Name 306, Address 308, City 310, State, 312, Zip Code 314, Service Name 316, and Service Type 318, Billing Account Number (BAN ID) 320, VoIP Telephone Number (VoIP TN) 322. The section further comprises associated configuration parameters, such as Residential Gateway ID (RG ID) 324, DSLAM Port 326, DSLAM Card 328, a first Set Top Box ID (IPTV STBID1) 330, a second Set Top Box ID (IPTV STBID2) 332, RG ID 334, and RG Internet Protocol Address (RG IP) 336. It is understood that data displayed in FIG. 3 are for illustrative purposes only and are not meant as a limitation on the present invention.

The Possible Network Events section 352 comprises a review of network events impacting service to the customer. The Module Selection section 354 comprises several checkboxes enabling the operator to test various services. In the exemplary embodiment, the operator can activate tests related to IPTV service 340, Internet service 342, VoIP service 344, and Email service 346. It is understood that the IP services displayed in FIG. 3 are for illustrative purposes only and are not meant as a limitation on the present invention.

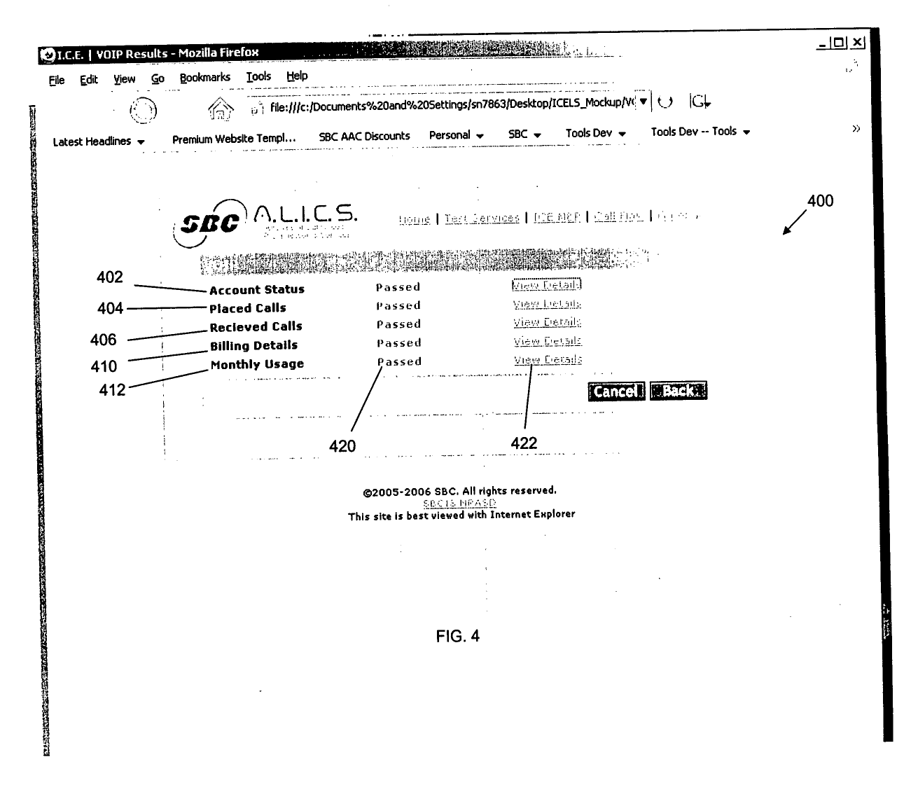

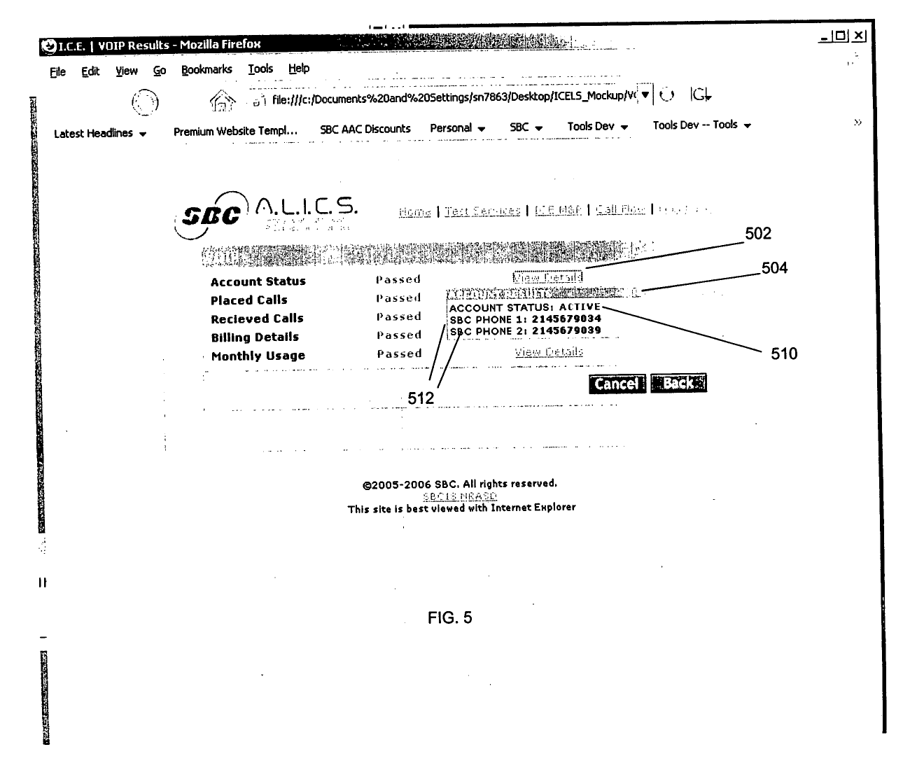

FIG. 4 illustrates an exemplary testing module 400 that can be selected via the checkbox for VoIP services (344) in FIG. 3. Some exemplary tests determine Account Status 402, a list of Placed Calls 404, a list of Received Calls 406, Billing Details 410, and Monthly Usage 412. The testing module further comprises a column for displaying test results 420 and a column of hyperlinks 422 which, when clicked upon, open a dialog box displaying test results in detail. FIG. 5, for example, illustrates a dialog box 504 with detailed test results of the customer's Account Status. The dialog box opens when the operator clicks on hyperlink 502. In the example of FIG. 5, the account status includes information such as whether the account is active 510 and any phone numbers 512 linked to the account.

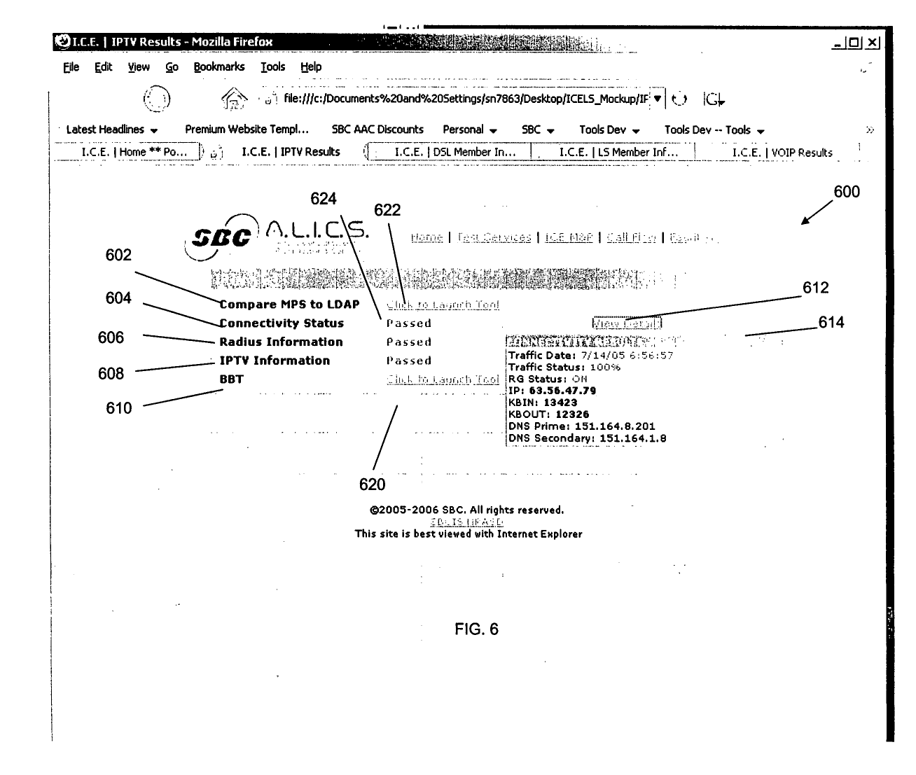

FIG. 6 shows an exemplary testing module 600 usable for testing IPTV service. The IPTV testing module comprises tests to compare MPS and LDAP data 602, to test connectivity status 604, to determine RADIUS Information 606, to obtain IPTV information 608 and to perform Broadband Testing (BBT) 610. RADIUS is a distributed security system that secures remote access to networks and network services against unauthorized access. LDAP, or “Lightweight Directory Access Protocol”, comprises an information model and a protocol for querying and manipulating the information model. The testing module 600 further comprises a column 620 for activating a test 622 and for displaying test results 624. Clicking an appropriate hyperlink 622 enables the operator to open a dialog box 614 displaying test results in detail.

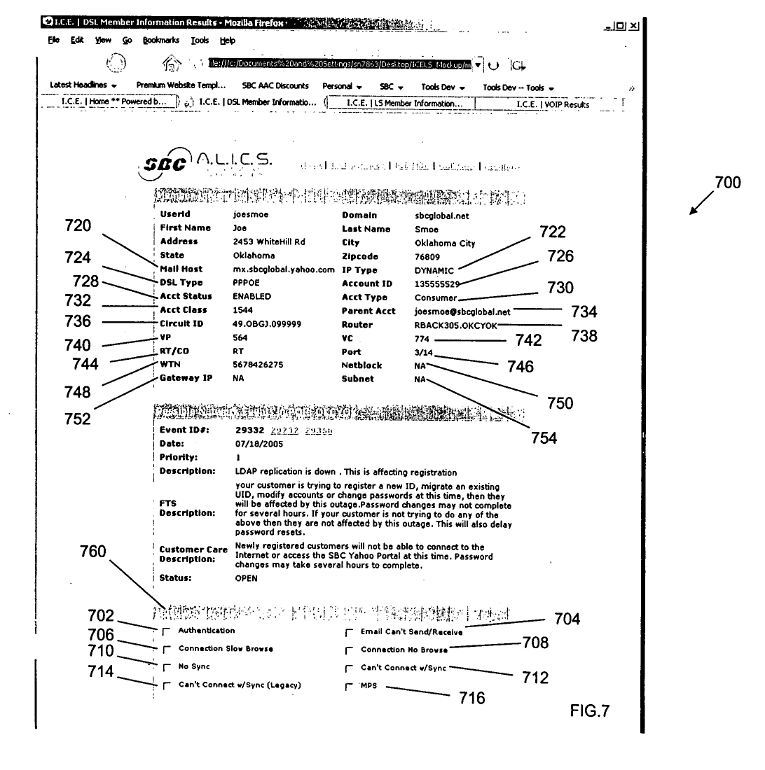

FIG. 7 illustrates a user interface 700 of the IP Tool providing customer information and testing options for a customer having a dynamic IP address connection to the network, such as through a DSL (Digital Subscriber Loop) connection to a local telephone company. The IP address in a DSL connection is usually different every time the customer connects. The Member Information section data set comprises customer information as well as associated configuration parameters, such as the Mail Host 720, the type of IP connection (IP Type) 722, the type of DSL connection (DSL Type) 724, an Account ID 726, an Account Status 728, an Account Type 730, an Account Class 732, a Parent Account 734, a Circuit ID 736, a router ID (Router) 738, a virtual path ID (VP) 740, a virtual circuit ID (VC) 742, a remote or central office indicator (RT/CO) 744, Port 746, working telephone number (WTN) 748, Netblock 750, Gateway IP 752, and Subnet 754. The operator can select various tests from the Module Selection section 760 to perform on the DSL connection. These tests generally detect network issues that occur in various equipment from end-to-end in a customer connection. Some exemplary testing modules include “Authentication” 702, “Email Can't Send/Receive” 704, “Connection Slow Browse” 706, “Connection No Browse” 708 “No Sync” 710, “Can't Connect w/Synch” 712, “Can't Connect w/Sync (Legacy)” 714, and MPS 716. It is understood that the specific set of testing modules listed above is only an illustration and is not meant as a limitation on the present invention.

The Authentication module 702 checks issues dealing with logging into the network, such as an incorrect password being entered at the CPE upon dial-up to the network, or Remote Access Dial-In User Service (RADIUS) and Lightweight Directory Access Protocol (LDAP) records not matching due to incomplete password replication to RADIUS servers, etc. The “Email Can't Send/Receive” module monitors 704 email server problems such as a full email box, a poorly-performing email server, poor connectivity between email server and customer, whether the server is down, etc. The email module tests the transport path from the customer, and verifies that the customer's user ID/Pass can authenticate with the customer POP mail server.

The “Connection/Slow Browse” module 706 tests for slow connectivity speeds between the CPE and the network, verifies the normal functioning of relevant DNS servers, and checks the transport layers of the customer connection for any degradation issues, among others. The “Connection/No Browse” module 708 typically tests whether the customer is connected and is using a valid IP address. These tests verify the level of TCP/IP layer traffic, verify the DNS, and test the speed of the connection.

The “NO sync” module 710 tests for DSLAM synchronization issues. A “Can't connect w/sync” module 712 includes tests that are involved with authentication, as well as the capability to verify the assigned dynamic IP address. PPPoE (Point-to-Point Protocol over Ethernet) testing can be performed. A “Can't connect—with sync (legacy static)” module 714 tests connectivity from the customer to the Telco network and includes ATM pings to test connections from the router to the customer and identifies any virtual path or circuit issues, TCP/IP pings, and DNS testing.

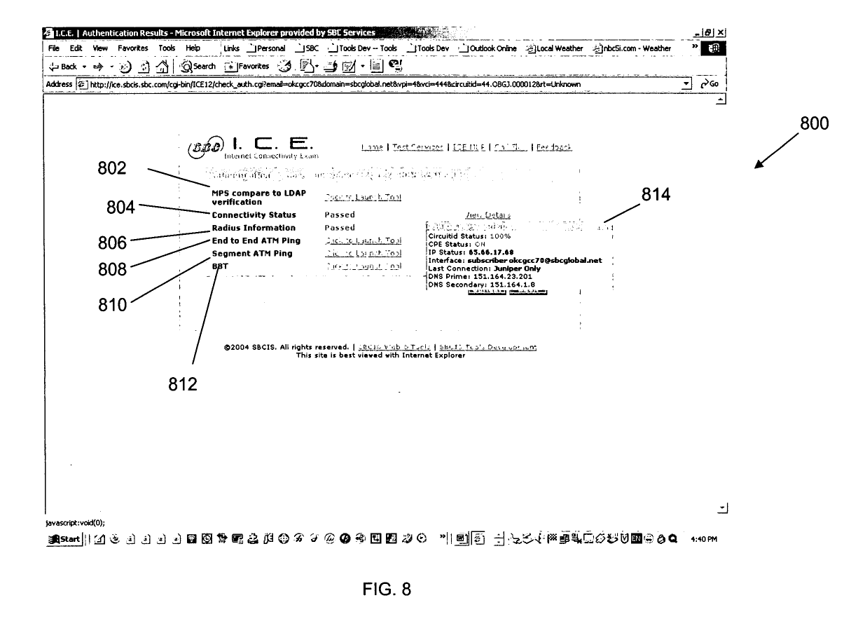

FIG. 8 shows an exemplary Authentication testing module 800 for determining authentication problems. FIG. 8 can be accessed from selecting checkbox 702 of FIG. 7. The exemplary authentication modules includes MPS/LDAP (Lightweight Directory Access Protocol) comparisons 802, connectivity status 804, RADIUS information testing 806, end-to-end ATM pinging 808, segmented ATM pinging 810, and Broadband testing (BBT) 812. It is understood that the exemplary authentication modules displayed in FIG. 8 are for illustrative purposes only and is not meant as a limitation on the present invention.

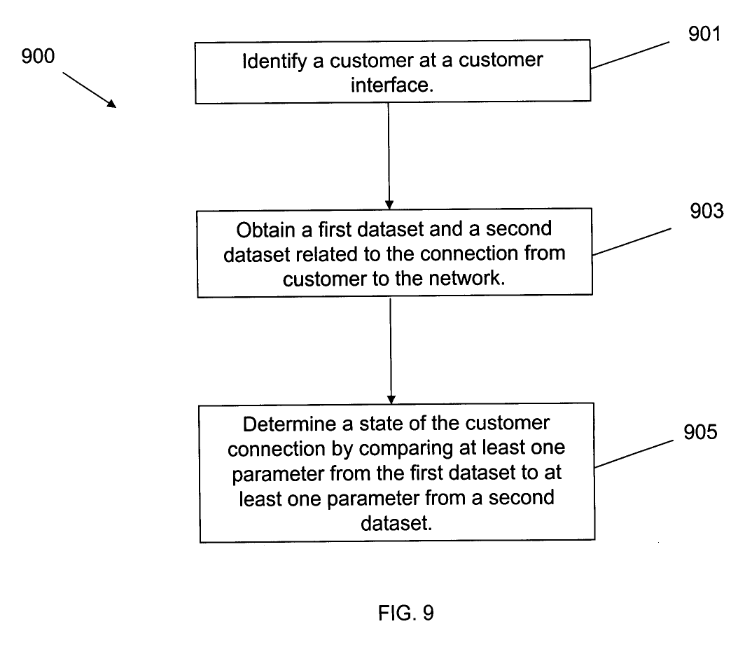

FIG. 9 shows a flowchart of an exemplary method of the present invention. In the Box 901, the IP Tool identifies the customer, usually by matching a telephone number or billing account identification number obtained at a user interface to a value stored in a customer database. The user interface can be, for instance, an IVR or a graphical user interface. In Box 903, the IP Tool obtains records, such as configuration parameters from a network element. Typically, the IP Tool obtains two datasets, such as a first dataset obtained of router configuration parameters and a second dataset of historical router configuration parameters (e.g. from an hour earlier). Historical data is generally obtainable from the any of the testing equipment associated with the appropriate domain: telephone company equipment, ISP equipment, etc. Multiple methods are available for obtaining data from the network devices. If the network device is a router, for instance, a testing module can log on to a router (via telnet, for instance) to check connections. An IP address can be obtained from the router for tracing purposes at a later time. An alternate testing tool “snoops” or listens at a port of the router to collect relevant data. The alternative testing tool (snooping) enables testing without significantly affecting performance levels of the router.

In Box 905, the IP Tool can compare data set values, such as tests results or configuration parameters, comprising an IP address or a Set Top Box identification number, for instance, from the first and second dataset in order to determine any changes or differences in configuration parameters in the two data sets that may relate to network problems. For example, a mismatch in a VoIP telephone number in the first and second dataset can be noted. Alternatively, the first and second datasets can be compared in light of a database of provisioning data sets. Usually, when a change is made in the network configuration, for example, an entry in a provisioning database records the change. If a change in telephone numbers, for example, is recorded in a provisioning database, yet the first and second dataset have the same telephone number, then an operator or customer can be notified as to the potential network problem or issue. Conversely, if a phone number or configuration changes between datasets without a corresponding entry in a provisioning data base, a network issue is indicated and an operator or customer can be notified as to the potential network problem or issue. Alternatively, configuration parameters obtained at a network element can be compared to configuration parameters stored in a customer database to detect network problems or issues. For example, an IP address obtained at a router can be compared to the corresponding IP address stored in the customer database. A mismatch between the two IP addresses can be brought to the attention of the network operator.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method of testing a customer connection to a communications network, comprising:
obtaining a customer identification at a customer interface;
obtaining at least a first dataset and a second dataset related to the customer connection to the communications network; and
comparing at least one parameter from the first dataset to at least one parameter from the second dataset to test the customer connection to the communications network.

2. The method of claim 1, wherein one of the datasets further comprise historical data related to the communications network.

3. The method of claim 1, wherein comparing the at least one parameter further comprises comparing the at least one parameter with a change of parameter recorded in a provisioning database.

4. The method of claim 1, wherein obtaining a first and second dataset further comprises obtaining a dataset from an operating system registry of a customer premises equipment.

5. The method of claim 1, wherein the first dataset is obtained at a network element and the second dataset is obtained from a customer database.

6. The method of claim 1, further comprising:
sending an alert of a network issue.

7. A system for comprehensively testing a customer connection to a communications network, comprising:
a customer interface for a customer identification;
a database for storing at least a first dataset and a second dataset related to the customer connection to the communications network; and
a processor configured to compare at least one parameter from the first dataset to at least one parameter from the second dataset to test the customer connection to the communications network.

8. The system of claim 7, wherein one of the datasets further comprise historical data related to the communications network.

9. The system of claim 7, wherein comparing the at least one parameter further comprises comparing the at least one parameter with a change of parameter recorded in a provisioning database.

10. The system of claim 7, wherein obtaining a first and second dataset further comprises obtaining a dataset from an operating system registry of a customer premises equipment.

11. The system of claim 7, wherein the first dataset is obtained at a network element and the second dataset is obtained from a customer database.

12. The system of claim 7, further comprising:
sending an alert of a network issue.

13. A computer readable medium containing instructions that when read by a computer perform a method for comprehensively testing a customer connection to a communications network, comprising:
obtaining a customer identification at a customer interface;
obtaining at least a first dataset and a second dataset related to the customer connection to the communications network; and
comparing at least one parameter from the first dataset to at least one parameter from the second dataset to test the customer connection to the communications network.

14. The medium of claim 13, wherein in the method one of the datasets further comprise historical data related to the communications network.

15. The medium of claim 13, wherein in the method comparing the at least one parameter further comprises comparing the at least one parameter with a change of parameter recorded in a provisioning database.

16. The medium of claim 13, wherein in the method obtaining a first and second dataset further comprises obtaining a dataset from an operating system registry of a customer premises equipment.

17. The medium of claim 13, wherein in the method the first dataset is obtained at a network element and the second dataset is obtained from a customer database.

18. The medium of claim 13, the method further comprising:
sending an alert of a network issue.
